(19) United States
(12) Patent Application Publication
(10) Pub. No.: US 2014/0251023 A1
(43) Pub. Date: Sep. 11, 2014

(54) CHEWING MONITORING DEVICE

(71) Applicant: Magomed Habibovich Magomedov, Moscow (RU)

(72) Inventor: Magomed Habibovich Magomedov, Moscow (RU)

(21) Appl. No.: 14/238,766

(22) PCT Filed: Mar. 23, 2012
(86) PCT No.: PCT/RU2012/000207

§ 371 Date: May 27, 2014

(30) Foreign Application Priority Data
Mar. 24, 2011 (RU) 2011111125

(51) Int. Cl. G01L 1/04; G01L 1/12

(52) U.S. Cl. CPC G01L 1/04; G01L 1/122
USPC 73/779

(57) ABSTRACT

The device for tracking masticatory movements makes it possible to calculate the number of masticatory movements. The device comprises a housing capable of elastic deformation under the action of the temporal and/or masseter muscles, a Hall sensor and a permanent magnet, which are mounted inside the housing with the possibility of shifting with respect to one another upon elastic deformation of the housing. The housing of the device can be designed such that it can surround the concha of the auricle of the user or such that it can be fitted in the concha of the auricle of a user.

### FIELD OF THE INVENTION

The invention relates to measuring devices used in biomedical methodology for studying movements of the human body or any parts thereof for diagnostic purposes, and more specifically, to devices for monitoring chewing movements in humans.

### BACKGROUND OF THE INVENTION

Device for monitoring movements of facial muscles are disclosed in patents EP 1516586, JP 2006129885, U.S. Pat. No. 6,893,406, and U.S. Pat. No. 7,421,233.

Further devices for monitoring chewing movements in humans are disclosed in patents JP 10011560, JP 7171136, JP 11123185, JP 2001178706, JP 2004242893, JP 2004242902, and JP 2005323213. These devices are the closest prior art of the first and second embodiments of the claimed device. The principal deficiency of these devices is that they are inconvenient in everyday use.

Earphones and a loudspeaker are disclosed, for example, in WO 2009/004401 of Jan. 8, 2009. An earphone capable of monitoring the user's chewing movements is not, however, disclosed anywhere in prior art.

### SUMMARY OF THE INVENTION

The technical effect achieved in the claimed devices for monitoring chewing movements consists in improved quality of filtering of mechanical vibrations by separating vibrations caused by chewing movements from the background noise of other vibrations caused, for example, by movements of the head or the jaw during conversation. This technical effect is achieved in a device housing designed to be capable of elastic deformation and to accommodate a Hall sensor and a permanent magnet moving relative to one another upon elastic deformation of the housing. In other words, the housing of the claimed device for monitoring chewing movements is an element of the chewing sensor.

The claimed technical effect also consists in the small size of the claimed devices for monitoring chewing movements, their convenience for use in everyday life because the housing is capable of surrounding the concha or being fitted into the user's concha, or an elastic headband is used, and also because the other elements of the device are arranged inside the housing.

A further technical effect achieved in the claimed devices for monitoring chewing movements and in the earphone is adaptation (selection) of the threshold number of chewing movements in each mastication cycle, from the first chewing movement after food has been taken into the mouth to the last chewing movement before swallowing, depending on the intensity, that is, frequency and amplitude, of chewing movements. This is an important effect because the frequency and amplitude of a chewing signal depend on food consistency—soft or hard, meat or soup, and so on. An increase in the chewing signal amplitude and decrease in its frequency means that the food has become harder and that the threshold number of chewing movements has to be increased.

These technical effects are achieved in a device for monitoring chewing movements that can be placed on a user's head in the area of the user's temporal muscles and/or masseters, said device comprising a housing capable of elastic deformation with movements of the temporal muscles and/or masseters, a Hall sensor and a permanent magnet fitted inside the housing for movement relative to one another upon elastic deformation of the housing, and a control unit that also processes information received from the Hall sensor.

The housing may be designed to surround the user's concha and be attached tightly to the user's temporal muscle and/or masseter.

The housing may be designed to fit into the user's concha.

The housing may consist of at least two parts joined elastically together, one of the housing parts carrying a Hall sensor and the other being provided with a permanent magnet.

The housing may have an elastically deformable wall to be provided with a permanent magnet.

The device may further be provided with a loudspeaker, a key for setting a threshold number of chewing movements in each mastication cycle, and a liquid-crystal display to show the current threshold value, the control and information processing unit being capable of detecting deviation of the number of chewing movements from the preset threshold value and transmitting a sound message to the user through the loudspeaker when the threshold value is reached.

The control and information processing unit may be designed to adjust the preset threshold number of chewing movements depending on the number of chewing movements per time unit and the intensity (amplitude) of chewing movements. By way of explanation, the required (threshold) number of chewing movements can be preset in the chewing monitoring device individually in each mastication cycle in the control and information processing unit by measuring the frequency and amplitude (intensity) of mastication that depend on food consistency. The chewing frequency and amplitude are different for hard food (meat, bread, and so on) and for soft food (soup, broth, salad, and so on), and the preset (appropriate) number of chewing movements can be increased or decreased by analyzing these differences to be adapted to the food chewed in each mastication cycle.

The device may be provided with a wire interface, for example, USB, or a wireless interface, for example, Bluetooth, for connection to external devices to transmit information to, or exchange information with, the external devices.

This technical effect is achieved in a chewing monitoring device that is capable of calculating the number of chewing movements and is designed to surround a user's head or neck with an elastic headband or neckband, said device comprising a first housing that is pressed by the headband against the user's head and is capable of elastic deformation in response to the movements of the temporal muscles and/or masseters, a Hall sensor and a permanent magnet provided inside the first housing for movement relative to one another upon elastic deformation of the housing, and a unit capable of controlling and processing information received from the Hall sensor.

The first housing may consist of at least two parts joined elastically to one another, one of said housing parts being provided with a Hall sensor and the other with a permanent magnet.

The first housing may have a deformable wall with a permanent magnet fitted thereto.

The device may have a second housing pressed by a headband against the user's head and being capable of elastic deformation, said second housing having a Hall sensor and at least one permanent magnet provided inside it for movement relative to one another upon elastic deformation of the housing, the control and information processing unit being capable of processing information from both Hall sensors.

This technical effect is achieved in an earpiece (applied to, or fitted on or into, the ear) serving to monitor chewing movements and comprising a Hall sensor and a permanent magnet provided inside the housing capable of elastic deformation and moving the Hall sensor and permanent magnet relative to one another, and a unit for controlling and processing information received from the Hall sensor. The control and information processing unit may be connected to the earpiece loudspeaker to transmit messages or signals to the user to monitor the food mastication process.

The housing may comprise at least two parts joined elastically to one another, one of said parts being provided with a Hall sensor and the other having a permanent magnet fitted thereto.

The housing may be designed with an elastically deformable wall having a permanent magnet fitted thereto.

The control and information processing unit may be provided inside the housing.

The earpiece may have a key provided on the housing for setting the threshold number of chewing movements during each mastication cycle and a liquid-crystal display to show the preset threshold value, both connected to the control and information processing unit.

The control and information processing unit may be designed to adjust the preset threshold number of chewing movements depending on the number of chewing movements per time unit and the amplitude (intensity) of chewing movements.

### BRIEF DESCRIPTION OF THE DRAWINGS

FIG. 1 is a general front view of the chewing monitoring device designed as an earpiece.

FIG. 2 is a projection of the chewing monitoring device.

FIG. 3 is a cross-sectional view of the chewing monitoring device of FIG. 2, showing the Hall sensor and magnets provided inside the housing.

FIG. 4 is a view of an alternative arrangement of a Hall sensor and a magnet inside the housing, with the magnet secured on an elastic ring.

FIG. 5 is a view of an alternative arrangement of a Hall sensor and a magnet inside the housing.

FIG. 6 is a block diagram of the chewing monitoring device.

FIG. 7 is a view of the chewing monitoring device having an elastic headband and comprising two housings of earpieces pressed by the headband against the user's head.

FIG. 8 is a cross-sectional view of one of the housings of the chewing monitoring device, provided with an elastic headband.

FIG. 9 is a view of the chewing monitoring device that can be placed in the concha.

### PREFERRED EMBODIMENTS OF THE DEVICE

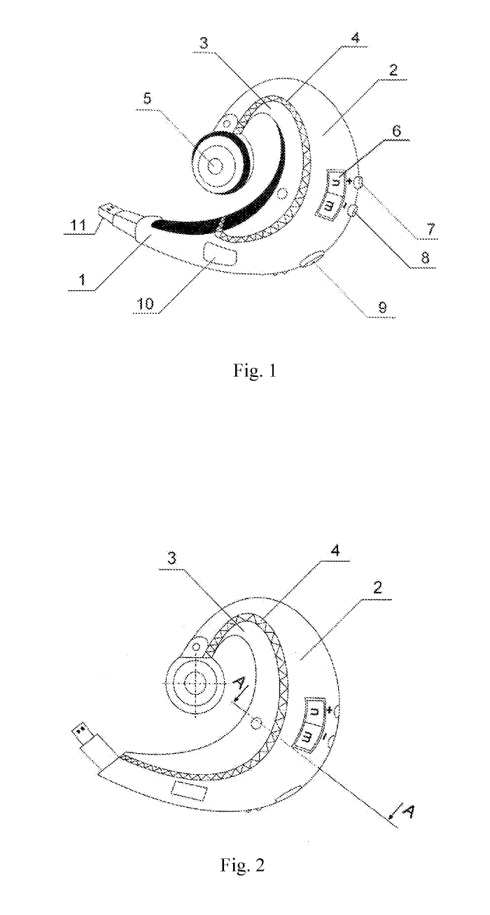

The chewing monitoring device shown in FIG. 1 is an earpiece having a housing 1 that comprises an upper part 2 and a lower part 3 separated by an elastic element, for example, an elastic ring (annular element) 4. The housing and its components may be made of plastic or Plexiglas, acryl, polystyrene, polyethylene, ABS, and so on. The plastic may be rubberized. The housing may be transparent. The elastic part of the housing may be made of metal or nonmetal. It is also possible to use these materials in combination. The elastic part of the housing must have appropriate stiffness for multiple uses as a spring, and may be coiled or helical, cylindrical or conical, spiral or flat, and so on. The elastic part of the housing may be in the form of a spring of steel, brass, bronze, and so on. Other possible materials are rubber, reinforced plastic, or a metal alloy.

The elastic part may be designed as a flat narrow strip, or a spiral, or a rod, or a membrane, or a bellows, or a tubular spring. It can contract, extend, bend, or twist, or perform combinations of these movements simultaneously.

A membrane is, for the purposes of this invention, a thin elastic, mostly round, flat or crimped plate fastened at the edges thereof. It may be made of metal or nonmetal. Nonmetal membranes can be made of rubber, rubberized silk, and leather. When a nonmetal membrane is used for joining components of the device housings, a spring, for example, a helical cylindrical spring, is to be added.

The earpiece is provided with a loudspeaker 5, a liquid-crystal display 6, and keys 7 and 8 for setting a threshold number of chewing movements in a mastication cycle to be shown on liquid-crystal display 6. FIG. 1 also shows location of a switch 9, a battery bay 10, and a USB port 11. FIG. 2 shows a projection of the earpiece, its outward view shown in FIG. 1.

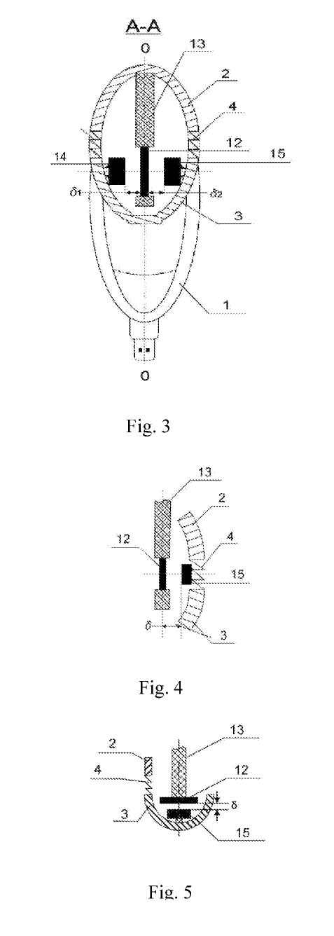

As is shown in the cross-sectional view of the earpiece of FIG. 3, the earpiece contains a Hall sensor fitted on a cantilever such as the board of a control and information processing unit 13 attached to the upper part of housing 2. Magnets 14 and 15 are secured to the walls of the lower part of housing 3 opposite to Hall sensor 12 at spacings δ₁ and δ₂ therefrom, respectively. When Hall sensor 12 is placed on the board of control and information processing unit 13, magnets 14 and 15 may be fitted on the elastic part of the housing, such as elastic ring 4, as shown in FIG. 4.

FIG. 5 is a view of an alternative location of magnet 15 and Hall sensor 12 attached to the board of control and information processing unit 13 normally to the axis O-O thereof in the elastic housing.

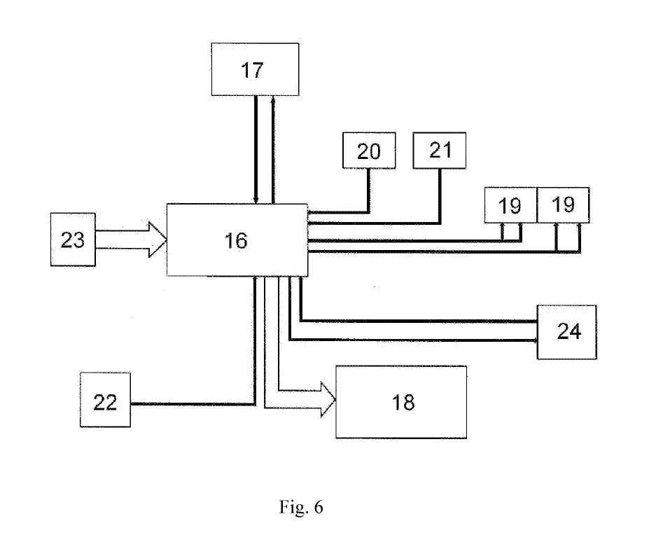

To enable the device to monitor chewing movements, it is provided with a control and information processing device in the form of a microcontroller 16 that is, as shown in FIG. 6, connected to a Hall sensor 17 (12 in FIG. 3), loudspeaker 18 (5 in FIG. 1), liquid-crystal display 19 (6 in FIG. 1), keys 20 and 21 (7 and 8 in FIG. 1), and also a switch 22 (9 in FIG. 1), a battery bay 23 (10 in FIG. 1), and a USB port 24 (11 in FIG. 1).

When the user puts on the earpiece shown in FIG. 1, lower part 2 of its housing adjoins the user's concha and/or head in the area of the temporal muscles and/or masseters. The temporal chewing muscles applying a force to lower part 3 of the housing shift it and cause it to vibrate relative to upper part 2 of the housing because of its inertia and elastic ring 4 joining parts 2 and 3 of the housing. Relative vibrations of housing parts 2 and 3 cause magnets 14 and 15 to shift relative to Hall sensor 12 and a signal to be generated in proportion to change in the spacings δ₁ and δ₂ between the magnets and the Hall sensor. Information generated by the Hall sensor is fed to microcontroller 16 (FIG. 6) and processed therein. Microcontroller 16 (FIG. 6) also counts the number of signals generated by chewing movements in each mastication cycle, compares the resultant output with the threshold number preset by keys 20 and 21 (7 and 8 in FIG. 1 and FIG. 2), and if the current number of chewing movements is equal to the threshold number in each mastication cycle, it sends a sound signal to the user, through loudspeaker 18 (5 in FIG. 1 and FIG. 2), to swallow the food.

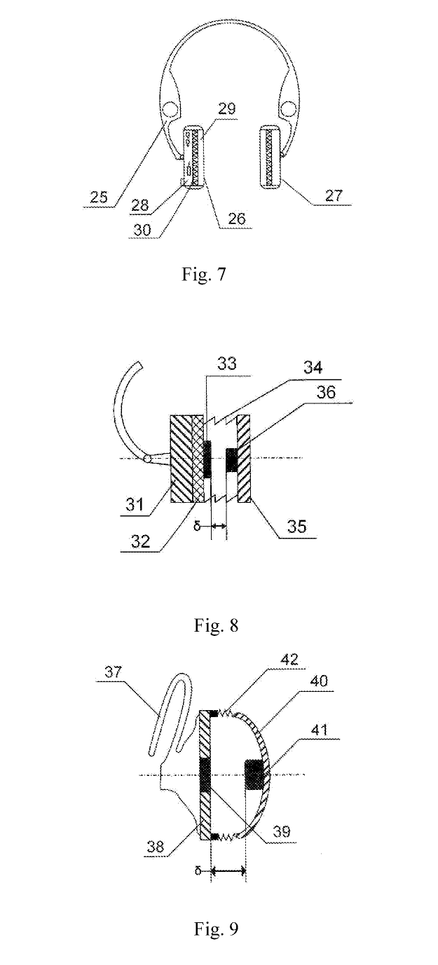

FIG. 7 shows another embodiment of the chewing monitoring device provided with an elastic headband 25 and comprising two housings 26 and 27 pressed by headband 25 against the user's head. In particular, the second embodiment of the chewing monitoring device may be designed in the form of earpieces connected by an elastic headband. Each of housings 26 and 27 comprises two components 28 and 29 connected by an elastic ring 30. The design of housing 26 is shown in greater detail in FIG. 8, wherein one part of the housing comprises a platform 31 and a plate 32 having a Hall sensor 33 fitted thereon. Plate 32 is connected, through an elastic ring 34, to the second housing part, a plate 35, on which a magnet 36 is fitted. The device may be provided with a loudspeaker, a liquid-crystal display, and keys to set a threshold number of chewing movements in a mastication cycle that is shown on the liquid-crystal display provided in either of the two housings together with a processor, a switch, a battery bay, and a USB port. Relative vibrations of the housing parts cause the magnets to vibrate relative to the Hall sensor and a signal to be generated. The microcontroller counts the number of vibrations, or chewing movements, in each mastication cycle, compares the result with the threshold number preset by keys 20 and 21 (7 and 8 in FIG. 1 and FIG. 2), and if the current number of chewing movements is equal to the threshold number in each mastication cycle, it sends a sound signal to the user through loudspeaker 18 (5 in FIG. 1 and FIG. 2) to swallow the food, whereupon a new food mastication cycle begins.

FIG. 9 shows a chewing monitoring device comprising an elastically deformable housing that can be fitted in the user's concha. The device has an elastic band 37 capable of surrounding the concha and connected to a housing comprising a first part such as a plate 38 with a Hall sensor 39 fitted thereon and a second part 40 having a magnet 41 provided thereon and connected to the first part by an elastic ring (annular element) 42. The device may be provided with a loudspeaker, a liquid-crystal display, and keys to set the threshold number of chewing movements in a mastication cycle that is shown on the liquid-crystal display in either of the housings together with a processor, a switch, a battery bay, and a USB port. The relative movement of the housing parts cause the magnets to vibrate relative to the Hall sensor and a signal to be generated and processed by the processor that counts the number of vibrations, or chewing movements, in each mastication cycle, compares the result with the threshold number preset by keys 20 and 21 (7 and 8 in FIG. 1 and FIG. 2), and if the number of current chewing movements is equal to the threshold number in each mastication cycle, it sends a sound signal to the user through loudspeaker 18 (5 in FIG. 1 and FIG. 2) to swallow the food, whereupon a new mastication cycle begins.

The embodiments of the chewing monitoring device and earpiece described above do not limit the number of possible embodiments thereof constructed in accordance with the claims. For example, embodiments of the devices may be built without a liquid-crystal display. In this case, the device in operation informs the user by a voice or sound signal about the threshold number of chewing movements stored in the microcontroller memory. The user can then push key 7 or 8 consecutively to increase or decrease the threshold number of chewing movements, each push of the keys causing the current threshold number to be announced through the loudspeaker.

What is claimed is:

1. A chewing monitoring device designed to be fitted on the user's head in the area of his temporal muscles and/or masseters, comprising a housing capable of elastic deformation in response to the movement of the temporal muscles and/or masseters, a Hall sensor, and a permanent magnet, both provided inside the housing for movement relative to one another upon elastic deformation of the housing, and a unit capable of controlling and processing the information received from the Hall sensor.

2. A device according to claim 1, wherein the housing is capable of surrounding the user's concha and being pressed against the user's temporal muscle and/or masseter.

3. A device according to claim 1, wherein the housing can be placed in the user's concha.

4. A device according to claim 1, wherein the housing comprises at least two parts joined elastically to one another, one of the parts carrying a Hall sensor and the other a permanent magnet.

5. A device according to claim 1, wherein the housing has an elastically deformable wall and a permanent magnet is fitted thereon.

6. A device according to claim 1, further comprising a loudspeaker, a key setting a threshold number of chewing movements in each mastication cycle, and a liquid-crystal display showing the preset threshold number, said loudspeaker, key, and display being connected to a control and information processing unit, said control and information processing unit being capable of detecting divergence of the current number of chewing movements from the preset number and sending a sound signal to the user through the loudspeaker when the threshold number is reached.

7. A device according to claim 1, wherein the control and information processing unit is capable to adjusting the preset threshold number of chewing movements depending on the number of chewing movements per time unit and the amplitude of the chewing movements.

8. A device according to claim 1, further provided with a wire or wireless interface for connection to external devices.

9. A chewing monitoring device having an elastic band and further comprising a first housing capable of elastic deformation in response to movements of the temporal muscles and/or masseters to be pressed against the user's head, a Hall sensor, and a permanent magnet, said Hall sensor and permanent magnet being capable of shifting relative to one another upon elastic deformation of the housing, and a unit controlling and processing information received from the Hall sensor.

10. A device according to claim 9, wherein the first housing comprises at least two parts joined elastically to one another, one of the housing parts carrying a Hall sensor and the other a permanent magnet.

11. A device according to claim 9, wherein the first housing has an elastically deformable wall for a permanent magnet to be fitted thereon.

12. A device according to claim 9, further comprising a second housing to be pressed by the headband against the user's head, said second housing being capable of elastic deformation and containing a Hall sensor and at least one permanent magnet that are capable of shifting relative to one another upon elastic deformation of the housing, and the control and information processing unit being capable of processing information received from both Hall sensors.

13. An earpiece to monitor chewing movements, comprising a Hall sensor and a permanent magnet, both provided inside the housing capable of elastic deformation and shifting the Hall sensor and permanent magnet, and also a unit controlling and processing information received from the Hall sensor, said unit being connected to a loudspeaker.

14. An earpiece according to claim 13, wherein the housing comprises at least two parts joined elastically to one another, one of said part having a Hall sensor fitted thereon and the other a permanent magnet.

15. An earpiece according to claim 13, wherein the housing is provided with an elastically deformable wall for a permanent magnet to be fitted thereon.

16. An earpiece according to claim 13, wherein the control and information processing unit is provided inside the housing.

17. An earpiece according to claim 13, further comprising a key to set a threshold number of chewing movements in each mastication cycle provided on the housing together with a liquid-crystal display to show the preset threshold number and both connected to the control and information processing unit.

18. An earpiece according to claim 13, wherein the control and information processing unit is capable of adjusting the preset threshold number of chewing movements depending on the number of chewing movements per time unit and the amplitude of chewing movements.
